(19) United States
(12) Patent Application Publication
(10) Pub. No.: US 2026/0016274 A1
(43) Pub. Date: Jan. 15, 2026

(54) Stylus

(71) Applicant: TPR CO., LTD., Tokyo (JP)

(72) Inventors: Shun Sugawara, Tokyo (JP); Masayuki Ohira, Tokyo (JP); Minoru UCHIYAMA, Tokyo (JP)

(21) Appl. No.: 19/137,473

(22) PCT Filed: Jul. 31, 2024
(86) PCT No.: PCT/JP2024/027410

§ 371 Date: Jun. 10, 2025

(30) Foreign Application Priority Data
Aug. 4, 2023 (JP) 2023-128085

(51) Int. Cl. G01B 5/016; G01B 5/20

(52) U.S. Cl. CPC G01B 5/016; G01B 5/202

(57) ABSTRACT

The present invention provides a stylus to be provided at the tip of a measuring probe,
wherein the stylus includes:
   a stylus tip whose outer peripheral surface is brought into contact with an object to be measured; and
   a stylus shaft whose one end is connected to the stylus tip;
wherein the stylus tip has a hard coating on the outer periphery thereof, and
wherein, when a protrusion of the hard coating extending locally from the outer peripheral surface and having a height of 1 μm or more is defined as a coating protrusion, a 0.10 mm×0.10 mm region of the outer peripheral surface of the stylus tip in which region the number of the coating protrusions is 5 or less, can be selected.

### TECHNICAL FIELD

The present invention relates to a stylus to be attached to the tip of a measuring probe for a two-dimensional or three-dimensional measuring apparatus, particularly, a measuring probe suitable for use in a scanning measurement.

### BACKGROUND ART

Two-dimensional or three-dimensional measuring apparatuses are used for the measurement of precision mechanical parts, such as gears.

Measuring probes are probes that are brought into contact with the surfaces of such precision mechanical parts and measure the shapes of the surfaces. In a continuous measurement method referred to as “scanning measurement”, among various measurement methods, the number of measurement points is much larger than that in a point measurement, and thus the reliability of the measured results is improved.

In the case of performing the scanning measurement, however, there is a problem that the measurement efficiency is deteriorated, because a longer measurement time is required unless the measurement is carried out at a higher measurement speed, due to an increased number of the measurement points. An increase in the measurement speed can cause new problems, such as the wear or breakage of a stylus tip included in a stylus attached to the tip of a measuring probe, the chipping of the tip, and scratches formed on a workpiece to be measured.

In cases where the wear or breakage of the stylus tip at the tip of the stylus, the chipping of the tip or the like occur during the scanning measurement, it may result in a situation where a re-measurement is required or the reliability of the acquired data is compromised. Further, in cases where a super hard material having an excellent wear resistance or the like is used for the body of the stylus tip in order to reduce the wear of the stylus tip to extend the service life, it results not only in a higher cost, but also in a higher risk of breakage of the stylus tip or chipping of the tip.

It is assumed that the hardness of the contact surface, the surface characteristics, the toughness and the like of the stylus tip, in addition to the measurement pressure and the measurement speed, have impacts on these problems.

In relation to the problems as described above, Patent Document 1 discloses, for example, a stylus whose tip ball has been subjected to a friction-reducing treatment with a DLC (diamond-like carbon) coating having a high hardness and a high wear resistance, for the purpose of providing a three-dimensional measuring apparatus which enables to perform a scanning measurement with a high accuracy, a high speed and stability, and a probe used in the apparatus.

Further, Patent Document 2 discloses a method of producing a stylus including a tip ball which has been subjected to such a friction-reducing treatment.

### RELATED ART DOCUMENTS

### Patent Documents

Patent Document 1: JP 2006-201105 A
Patent Document 2: JP 2019-190999 A

### SUMMARY OF THE INVENTION

### Problems to be Solved by the Invention

In cases where the stylus tip is subjected to a treatment to provide a coating with a high hardness as described in Patent Document 1 or 2, however, the present inventors have found out that there are cases where a reduction in the peeling, wear or damage of the coating provided on the stylus tip and the reduction of scratches formed on a workpiece to be measured cannot necessarily be achieved at the same time depending on the conditions such as the type of the object to be measured and the measurement speed, while a higher efficiency due to an even higher measurement speed is desired.

In other words, there are problems that the service life of the stylus tip and the reduction of scratches formed on the workpiece to be measured may be insufficient, in a conventionally disclosed stylus.

The present invention has been done in view of the above-mentioned problems, and an object of the invention is to provide a stylus which is capable of reducing the wear of a stylus tip provided at the tip of a measuring probe and scratches formed on a workpiece, and extending the service life, as well as reducing scratches formed on the workpiece to be measured.

### Means for Solving the Problems

As a result of studies to solve the above-mentioned problems, the present inventors have newly found out that the presence of protrusions generated during the formation of a hard coating on the outer periphery of the stylus tip is largely related to the problems described above. In general, a DLC coating formed by chemical vapor deposition (CVD) using a hydrocarbon gas as a raw material, has a characteristic that a smaller number of protrusions are generated due to the process of forming the coating, but has a wear resistance inferior to a DLC coating formed by physical vapor deposition (PVD) using solid carbon as a raw material. Therefore, a DLC coating formed by the PVD method is suitable for a member in which the occurrence of wear or scratches is an issue. However, the present inventors have found out the above-mentioned problems occur in a DLC coating formed by the PVD method, because a larger number of protrusions are generated as compared to a DLC coating formed by the CVD method. As a result of various examinations on the conditions at the time of forming the hard coating on the outer periphery of the stylus tip, the present inventors have found out that the problems described above can be solved by forming a hard coating satisfying specific requirements on the outer periphery of the stylus tip, thereby completing the present invention.

The present invention relates to a stylus to be provided at the tip of a measuring probe,
wherein the stylus includes:
   a stylus tip whose outer peripheral surface is brought into contact with an object to be measured; and
   a stylus shaft whose one end is connected to the stylus tip;
wherein the stylus tip has a hard coating on the outer periphery thereof, and
wherein, when a protrusion of the hard coating extending locally from the outer peripheral surface and having a height of 1 μm or more is defined as a coating protrusion, a 0.10 mm×0.10 mm region of the outer peripheral surface of the stylus tip in which region the number of the coating protrusions is 5 or less, can be selected.

### Effect of the Invention

According to the present invention, it is possible to provide a stylus tip which is capable of reducing the wear or damage of the stylus tip provided at the tip of a measuring probe, and extending the service life, in a measuring probe for a two-dimensional or three-dimensional measuring apparatus, as well as reducing scratches formed on a workpiece to be measured.

### BRIEF DESCRIPTION OF THE DRAWINGS

FIG. 1 is a schematic diagram showing one example of the configuration of a measuring probe.

FIG. 2 shows cross-sectional schematic diagrams each showing the vicinity of the contact portion of a stylus tip. FIG. 2(a) is an example of the case in which the shape of the stylus tip is in the form of a sphere, and FIG. 2(b) is an example of the case in which the shape of the stylus tip is in the form of an abacus bead.

FIG. 3 is a photograph showing coating protrusions on a hard coating.

FIG. 4 is a photograph showing a test device for a wear test.

### MODE FOR CARRYING OUT THE INVENTION

### One Embodiment of the Present Invention is:

a stylus to be provided at the tip of a measuring probe,
wherein the stylus includes:
   a stylus tip whose outer peripheral surface is brought into contact with an object to be measured; and
   a stylus shaft whose one end is connected to the stylus tip;
wherein the stylus tip has a hard coating on the outer periphery thereof, and
wherein, when a protrusion of the hard coating extending locally from the outer peripheral surface and having a height of 1 μm or more is defined as a coating protrusion, a 0.10 mm×0.10 mm region of the outer periphery of the stylus tip in which region the number of the coating protrusions is 5 or less, can be selected.

Specific embodiments of the stylus will be described below. However, the configurations described in the following embodiments are not intended to limit the technical scope of the invention only to these configurations, unless otherwise defined.

The stylus according to the present embodiment can be provided at the tip of a measuring probe for a measuring apparatus. The configurations of the measuring apparatus and the measuring probe are not particularly limited, and the stylus can be used, for example, in a three-dimensional measuring apparatus for measuring precision mechanical parts such as gears, and a measuring probe of the apparatus.

### <Stylus>

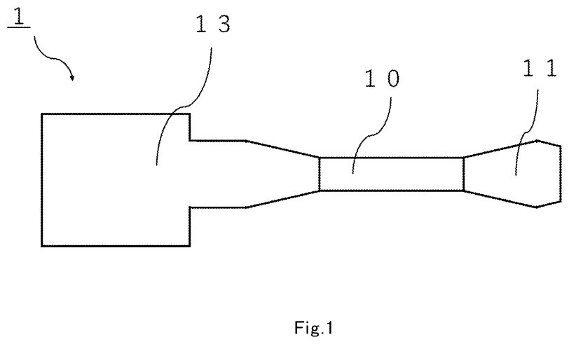

A measuring probe including the stylus according to the present embodiment will be described with reference to FIG. 1.

FIG. 1 is a schematic diagram showing one example of a measuring probe including the stylus according to the present embodiment. The stylus attached to the measuring probe is composed of a stylus shaft and a stylus tip. In FIG. 1, the vertical direction is defined as “radial direction”, and the right-and-left direction is defined as “axial direction”.

FIG. 1 shows a stylus 1 including a stylus shaft 10, and a stylus tip 11 provided on the tip side of the stylus shaft 10. One end of the stylus shaft 10 is connected to the stylus tip 11. The outer peripheral surface of the stylus tip 11 is brought into contact with an object to be measured, to carry out a measurement. The stylus tip 11 has a hard coating on the outer periphery thereof.

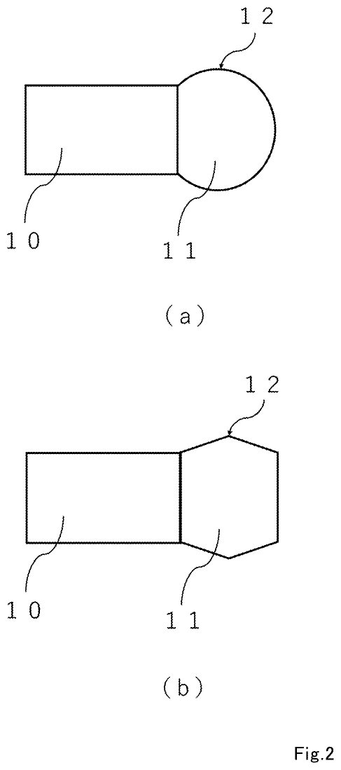

In the present specification, the term “contact portion” refers to a portion of the outer peripheral surface of the stylus tip 11 at which the stylus tip 11 is brought into contact with the object to be measured. The entire outer peripheral surface of the stylus tip 11 can be the contact portion, depending on the shape of the stylus tip 11 and the object to be measured. As indicated by reference numeral 12 in each of FIGS. 2(a) and (b), the contact portion is, for example, a portion of the outer peripheral surface of the stylus tip 11 located furthest from the central axis of the stylus shaft 10.

In the example shown in FIG. 1, the shape of the stylus shaft 10 is in the form of a cylinder, and the shape of the stylus tip 11 is in the form of an abacus bead. However, the shape of the stylus shaft 10 is not particularly limited, and may be in the form of a cone or a rectangular parallelepiped.

Further, the shape of the stylus tip 11 may be, for example, in the form of a barrel, a sphere, a semi-sphere, a cone, a cylinder, or a disk. FIG. 2(a) shows a stylus tip in the form of a sphere, and (b) shows a stylus tip in the form of an abacus bead.

The material of the substrate of each of the stylus shaft 10 and the stylus tip 11 is not particularly limited. The material may be a magnetic material or a non-magnetic material, and may be, for example, steel, ruby, a cemented carbide or the like, but not particularly limited thereto. Further, a material having a low thermal expansion and contraction is desired.

### <Hard Coating>

The stylus tip 11 has a hard coating on the outer periphery thereof.

The hard coating is required to cover at least a portion of the outer periphery of the stylus tip 11 including the contact portion. From the viewpoint of the production, however, the hard coating preferably covers the entire outer periphery of the stylus tip 11. Further, the hard coating may cover at least a portion of the outer periphery of the stylus shaft 10.

The stylus tip 11 may have a different coating and/or a base layer, between the substrate of the stylus tip 11 and the hard coating at the outermost surface. In cases where the stylus tip 11 has a plurality of coatings, the “hard coating” hereinafter refers to a hard coating at the outermost surface, unless otherwise specified.

The composition of the hard coating is not particularly limited. However, the hard coating is preferably at least one selected from the group consisting of a DLC coating, a chromium nitride coating and a titanium nitride coating, because of their excellent wear resistance. Further, the hard coating is more preferably a DLC coating, and still more preferably a so-called hydrogen-free DLC coating having a hydrogen content of 5.0 at % or less. The hydrogen content may be 2 at % or less, 1 at % or less, or 0.5 at % or less.

The present inventors have found out the fact that the coating protrusions present on the surface of the hard coating are related to the balance between the reduction in the wear of the stylus tip 11 and the reduction of scratches formed on a workpiece to be measured.

In the present specification, the term “coating protrusion” refers to a protrusion of the hard coating extending locally from the outer peripheral surface of the stylus tip and having a height of 1 μm or more, when the surface of the hard coating on the outer periphery of the stylus tip is measured under the following conditions.

The method of measuring the number of coating protrusions will be described below.

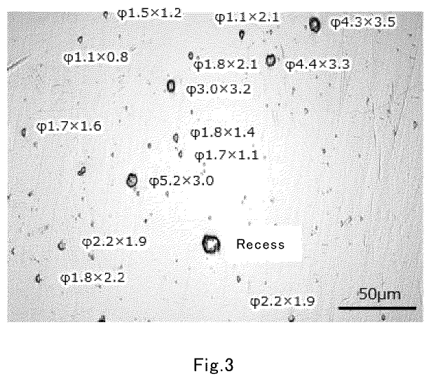

FIG. 3 is a photograph obtained by observing the coating protrusions on the surface of the hard coating under the following conditions.
Hard coating: a hydrogen-free DLC coating; hydrogen content: 0.3 at %; coating thickness: 4 μm
Measurement device: a laser microscope VK-X100, manufactured by KEYENCE Corporation
Measurement magnification: objective lens with a 50 times magnification
Measurement field: 0.20 mm×0.27 mm

In FIG. 3, the description “φ1.7×1.6”, for example, indicates that the longer diameter of the corresponding coating protrusion is 1.7 μm, and the height of the coating protrusion is 1.6 μm.

### <Method of Measuring Number of Coating Protrusions>

The number of protrusions on the surface of the hard coating is measured in accordance with the following method. Specifically, using a laser microscope VK-X100, manufactured by KEYENCE Corporation, the surface of the object to be measured is observed with an objective lens with a magnification of 50 times, to acquire a microscopic image and three-dimensional data. The measurement is performed with a measurement field of 0.20 mm×0.27 mm. The measurement field may be changed as appropriate, depending on the size and the shape of the stylus tip, which is the object to be measured. The captured image is trimmed to an arbitrarily selected visual field of 0.10 mm×0.10 mm. Subsequently, abnormal data values upon acquiring the image are removed by automatic noise removal, which is an additional function of the laser microscope analysis application, and the tilt of the outer peripheral surface at the time of the measurement is corrected to a plane by automatic surface tilt correction. Thereafter, a horizontal line is drawn in the image, in the profile view, the number of protrusions having a height of 1 μm or more relative to the outer peripheral surface is measured, and the measured number is defined as the number of coating protrusions present in the corresponding 0.10 mm×0.10 mm region. The diameter of the protrusions may also be measured at the time of measuring the height thereof.

In the present embodiment, a 0.10 mm×0.10 mm region in which the number of the coating protrusions is 5 or less can be selected when the number of coating protrusions is measured by the method described above.

It is more preferred if a 0.10 mm×0.10 mm region in which the number of the coating protrusions is 3 or less can be selected. When the hard coating is formed so that such a 0.10 mm×0.10 mm region can be selected, it is possible to reduce the formation of scratches during the measurement.

The coating protrusions on the surface of the hard coating can be generated at the time of forming the hard coating on the outer periphery of the stylus tip 11. The coating protrusions are protrusions generated when massive molten particles referred to as “droplets” are produced when raw materials are evaporated by plasma and adhered to the coating. The present inventors have discovered that it is possible to achieve both a reduction in the wear of the stylus and the reduction of scratches formed on the workpiece to be measured, by controlling the height and the number of the coating protrusions within specific ranges.

The coating protrusions preferably have a maximum height of 8 μm or less, more preferably 7 μm or less, and particularly preferably 5 μm or less. When the maximum height of the coating protrusions is 8 μm or less, it is possible to reduce the formation of deep scratches during the measurement.

The coating protrusions preferably have a longer diameter of 12 μm or less, more preferably 9 μm or less, and particularly preferably 7 μm or less. When the coating protrusions have a longer diameter of 12 μm or less, it is possible to reduce the formation of deep scratches during the measurement.

The hard coating preferably has a nanoindentation surface hardness of from 12 to 30 GPa. When the surface hardness of the hard coating is 12 GPa or more, the wear of the stylus tip 11 is reduced. When the surface hardness of the hard coating is 30 GPa or less, it is preferred from the viewpoint of reducing the peeling of the hard coating and the viewpoint of the production. The surface hardness of the hard coating is more preferably within the range of from 15 to 28 GPa.

In general, the hardness of the hard coating is the higher the more preferred, in view of the wear resistance. However, it is preferred to control the hardness within the range described above, because too high a hardness of the hard coating tends to make the hard coating more susceptible to peeling.

The surface hardness of the hard coating can be adjusted by selecting the material of the hard coating or by controlling the treatment conditions during the formation of the coating.

The hard coating in the above-described 0.10 mm×0.10 mm region preferably has a thickness of from 3 to 10 μm. When the thickness of the hard coating is more than 10 μm, there is a risk that the hard coating may peel, or a risk that it may be difficult to control the height of the protrusions of the hard coating. The lower limit of the thickness of the hard coating may be 3 μm or more, or 5 μm or more. The upper limit of the thickness thereof may be 8 μm or less, or 6 μm or less. When the thickness of the hard coating is 3 μm or more, a sufficient effect of reducing the wear by the hard coating is more likely to be obtained, and thus is preferred.

In cases where another coating and/or a base layer is/are present between the substrate of the stylus tip and the hard coating at the outermost surface, it is preferred that the total thickness including the other coating and/or the base layer be within the range described above.

The thickness of the hard coating can be adjusted as appropriate, by controlling the conditions during the formation of the coating.

Further, the present inventors have found out that, when the object to be measured has a gear-like shape, the stylus is intermittently brought into contact with the object to be measured during the measurement, and the impact due to the contact makes the stylus more susceptible to chipping (damage). From the viewpoint of reducing such a problem, the plastic deformation work (Wₚₗₐₛₜ) of the hard coating, as measured by a nanoindentation test at a load of 100 mN, is preferably 6.0 nJ or more.

The term “plastic deformation work” (plastic deformation energy) (Wₚₗₐₛₜ) refers, when an indenter is pressed onto the coating surface in a nanoindentation test, to the work consumed by the indenter for the plastic deformation that allows the coating to remain deformed even when the indenter is unloaded, of the work consumed by the indenter for the deformation of the coating. Further, the term “elastic deformation work (elastic deformation energy) (Wₑₗₐₛₜ)” refers to the work released when the indenter is unloaded to allow the coating to restore its original state. The “plastic deformation power (ηₚₗₐₛₜ)” serves as an index that characterizes whether or not the coating is susceptible to plastic deformation when a foreign object is pressed onto the coating surface. When the plastic deformation work (Wₚₗₐₛₜ) of the hard coating, as measured by a nanoindentation test at a load of 100 mN, is 6.0 nJ or more, the peeling of the coating due to impact loading during the measurement can be reduced, and thus is preferred.

Further, the plastic deformation work (Wₚₗₐₛₜ) of the hard coating as measured by the nanoindentation test is more preferably 6.4 nJ or more. The upper limit value of the plastic deformation work (Wₚₗₐₛₜ) is not particularly limited. However, a value of 10.5 nJ or less is suitable as the upper limit, because too high a value results in a failure to maintain the hardness that satisfies the requirement for the wear resistance.

The nanoindentation test is carried out using a nanoindentation measuring device, Model HM-2000, manufactured by Fischer instruments K.K. and using a Vickers indenter, under the conditions of an indentation load of 100 mN, a loading time until reaching the maximum indentation load of 30 s (seconds), a retention time of 5 s (seconds) and an unloading time of 30 s (seconds). The plastic deformation work, the elastic deformation work and the nanoindentation hardness of the hard coating are calculated using a load-indentation depth curve obtained in the nanoindentation test. The measurement is carried out at three points on the entire circumference, in the circumferential direction of the hard coating on the outer periphery of one stylus tip, and the mean value of the three measured values is taken as the measured value.

Further, the total work (Wₜₒₜₐₗ; also referred to as total deformation work), as measured by the nanoindentation test and calculated by the following Equation (1), is preferably 18.0 nJ or more. The upper limit value of the total work is not particularly limited, but a value of 24.0 nJ or less is suitable as the upper limit.

When the total work satisfies the range described above, it is possible to achieve both good wear resistance and a reduction in the peeling of the coating due to the impact loading during the measurement.

$${W}_{total} = {W}_{plast} + {W}_{elast} \qquad ( 1 )$$

Still further, the plastic deformation power (ηₚₗₐₛₜ), as measured by the nanoindentation test and calculated by the following Equation (2), is preferably 32.4% or more. The plastic deformation power is more preferably 33.0% or more, and still more preferably 34.0% or more. The upper limit value of the plastic deformation power is not particularly limited, but a value of 45.0% or less is suitable as the upper limit.

When the plastic deformation power satisfies the range described above, it is possible to achieve both a good wear resistance and a reduction in the peeling of the coating due to the impact loading during the measurement.

$${η}_{p l a s t} = ( {W}_{p l a s t} / {W}_{total} ) \times 100 ( \% ) \qquad ( 2 )$$

In addition, the ratio (HIT/Wₚₗₐₛₜ) of the nanoindentation hardness (HIT) to the plastic deformation work (Wₚₗₐₛₜ), as measured by the nanoindentation test, is preferably 4.5 GPa/nJ or less, and more preferably 4.1 GPa/nJ or less. The lower limit value of the ratio (HIT/Wₚₗₐₛₜ) of the nanoindentation hardness (HIT) to the plastic deformation work (Wₚₗₐₛₜ) is not particularly limited, but a value of 1.5 GPa/nJ or more is suitable as the lower limit.

When the ratio (HIT/Wₚₗₐₛₜ) satisfies the range described above, it is possible to achieve both a good wear resistance and a reduction in the peeling of the coating due to the impact loading during the measurement.

The formation of a hard coating (coating forming step) on the stylus tip 11 may be carried out, for example, by a physical vapor deposition (PVD) method such as ion plating or sputtering. PVD is preferred from the viewpoint that the resulting DLC coating has a wear resistance required for the measurement using the stylus. The “physical vapor deposition (PVD)” is one type of vapor deposition method in which particles ejected from the target are allowed to adhere to a substrate to form a coating on the surface of a substance, and can also be referred to as “physical vapor transport”. Examples of the PVD method can include methods such as ion plating, vacuum vapor deposition, ion beam vapor deposition, sputtering and filtered cathodic vacuum arc (FCVA) deposition. Examples of the vapor deposition method can also include chemical vapor deposition (CVD) such as thermal CVD and plasma CVD.

The number and the size of the coating protrusions of the hard coating can be adjusted to the desired values by adjusting the method of producing the hard coating. More specifically, for example, decreasing the value of arc current, which is one of the coating formation parameters, leads to a decrease in the surface temperature of a molten spot referred to as “arc spot” which is generated on the target surface during vacuum arc discharge. This makes it possible to decrease the amount of the molten particles referred to as droplets, which causes the generation of the coating protrusions. Further, decreasing the diameter of the aperture, which is a path through which carbon ions released from the target pass until adhering to the substrate, enables the trapping of the droplets ejected from the target inside the path, making it possible to decrease the amounts of droplets in the coating.

The plastic deformation work as measured by the nanoindentation test described above can be adjusted to a desired value, by adjusting the method of producing the hard coating. More specifically, in cases where the hard coating is formed using the FCVA method, the plastic deformation work can be adjusted to a desired value, by adjusting the pulse bias voltage to be applied, the substrate temperature during the formation of the hard coating, the chamber pressure (degree of vacuum), the arc current, the purity of the target and the like.

In cases where the hard coating includes a DLC coating, the DLC coating may be a DLC coating containing hydrogen, or may be a so-called hydrogen-free DLC coating. For example, the proportion of hydrogen element in the DLC coating may be 5.0 at % or less. A DLC coating with a high hydrogen content has a wear resistance inferior to a DLC coating which does not contain hydrogen.

A known method can be used as the method of forming a DLC coating which does not contain hydrogen, and examples of the method include ion plating and sputtering.

The hard coating may contain another element(s), such as for example, Si, Ti, W, Cr, Mo, Nb, V and/or the like, but not particularly limited thereto. In cases where the hard coating contains any of these elements, the total amount thereof is preferably 40 at % or less.

Further, the stylus substrate may include a base layer containing Cr, Ti, Si and/or the like, on the substrate of the stylus. By providing a base layer, it is possible to improve the adhesion between the substrate of the stylus tip and the hard coating.

The stylus according to the present embodiment is completed through the step described above, but a surface treatment such as buffing may be performed after the coating formation.

### Examples

The present invention will be described below in detail with reference to Examples. However, the present invention is in no way limited to the following Examples alone.

Each of the styluses of Examples 1 and 2 and Comparative Examples 1 to 3 was prepared, by selecting the material of the stylus tip and adjusting the hard coating on the outer periphery as shown in Table 1.

TABLE 1

| Comparative | | Type of | Number of coating |
|---|---|---|---|
| Example/Example | Material | Coating | protrusions (number) |
| Example 1 | Alloy tool | DLC | 2 |
| | steel | | |
| Example 2 | Alloy tool | DLC | 5 |
| | steel | | |
| Comparative | Alloy tool | Not formed | — |
| Example 1 | steel | | |
| Comparative | Cemented | Not formed | — |
| Example 2 | carbide | | |
| Comparative | Alloy tool | DLC | 9 |
| Example 3 | steel | | |

The amount of wear of each stylus tip shown in Table 2 was determined by carrying out the following wear test.

TABLE 2

| | Amount of wear of stylus tip (μm) | | | | | |
|---|---|---|---|---|---|---|
| Comparative | Test time (min) | | | | | |
| Example/Example | 50 | 100 | 500 | 1000 | 1500 | 2000 |
| Example 1 | 0 | 0 | 0 | 0 | 0 | 0.2 |
| Example 2 | 0 | 0 | 0 | 0 | 0.5 | 0.8 |
| Comparative | 7 | 12 | 30 | — | — | — |
| Example 1 | | | | | | |
| Comparative | 0 | 1 | 2 | 4 | 4.5 | 5 |
| Example 2 | | | | | | |

### <Wear Test>

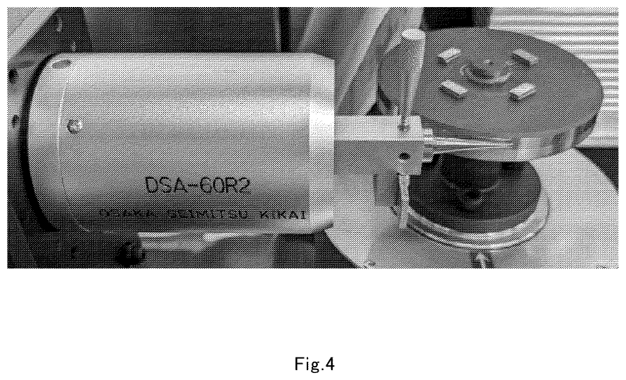

The probe was attached to the test device shown in FIG. 4, brought into contact with a cylindrical workpiece under the following conditions, and the workpiece was rotated for a predetermined test time as shown in Table 2. The portion of the stylus tip brought into contact with the workpiece was observed with a microscope, before and after the test, and the amount of wear was calculated.

### Test Conditions

Amount of indentation (indentation force): 150 μm (about 25 g)
Stylus tip: tip in the form of an abacus bead, diameter: φ1.5 mm
Diameter of workpiece: φ70 mm
Material of workpiece: alloy tool steel
Surface roughness of workpiece: Ra 1.5 mm
Rotational speed of workpiece: 1.5 rpm (scanning speed: 5.5 mm/seconds)

### <Evaluation of Scratches on Workpiece>

The scratches formed on the workpiece due to the contact with the stylus tip were evaluated by carrying out a test using a reciprocating wear tester, under the following conditions that are more stringent than those for the wear test described above.

### Test Conditions

Pressing load: 2.5 N
   Stroke: 50 mm
   Speed: 100 strokes/minutes
   Lubricating oil: not used (no lubricant=dry)
   Upper test piece: stylus tip
   Lower test piece: chromium molybdenum steel, with mirror finished surface
   Test time: 30 seconds

The depth and the number of scratches formed on the lower test piece were measured after the test, and the evaluation was performed in accordance with the following criteria. It was evaluated as “NG” when the formation of any scratches with a depth of 1.5 μm or more was observed, and it was evaluated as “OK” when the formation of such scratches was not observed. Further, it was evaluated as “C” when the formation of five or more scratches with a depth of 0.5 μm or more and less than 1.5 μm was observed, it was evaluated as “B” when the formation of from one to four such scratches was observed, and it was evaluated as “A” when the formation of such scratches was not observed. The results are shown in Table 3.

TABLE 3

| Example | Depth of scratches | Number of scratches |
|---|---|---|
| Example 1 | OK | A |
| Example 2 | OK | B |
| Comparative | NG | C |
| Example 3 | | |

As is evident from the Examples described above, it is possible to carry out a measurement operation while reducing the wear of the stylus tip and reducing the scratches formed on the workpiece to be measured, by providing the stylus tip according to the present embodiment to the tip of a measuring probe.

While the present invention is described in detail with reference to specific Examples, it is evident to those skilled in the art that various changes and modifications can be made without departing from the gist and the scope of the present invention.

### DESCRIPTION OF SYMBOLS

1 stylus
10 stylus shaft
11 stylus tip
12 contact portion
13 probe

1. A stylus to be provided at the tip of a measuring probe,
wherein the stylus comprises:
a stylus tip whose outer peripheral surface is brought into contact with an object to be measured; and
a stylus shaft whose one end is connected to the stylus tip;
wherein the stylus tip comprises a hard coating on the outer periphery thereof and the hard coating has a nanoindentation hardness of 12 GPa or more and 30 GPa or less, and
wherein, when a protrusion of the hard coating extending locally from the outer peripheral surface and having a height of 1 μm or more is defined as a coating protrusion, a 0.10 mm×0.10 mm region of the outer peripheral surface of the stylus tip in which region the number of the coating protrusions is 5 or less, can be selected at least one region.

2. The stylus according to claim 1, wherein the hard coating in the 0.10 mm×0.10 mm region has a coating thickness of 3 μm or more and less than 10 μm.

3. (canceled)

4. The stylus according to claim 1, wherein the hard coating is a hard DLC coating having a hydrogen content of 5.0 at % or less.

5. The stylus according to claim 1, wherein the plastic deformation work (Wₚₗₐₛₜ) of the hard coating, as measured by a nanoindentation test at a load of 100 mN, is 6.0 nJ or more.

6. The stylus according to claim 1, wherein the total work (Wₜₒₜₐₗ) of the hard coating, as measured by the nanoindentation test at a load of 100 mN and calculated by the following Equation (1), is 18.0 nJ or more:
$${W}_{total} = {W}_{plast} + {W}_{elast} . \qquad ( 1 )$$

7. The stylus according to claim 1, wherein the plastic deformation power (ηₚₗₐₛₜ) of the hard coating, as measured by the nanoindentation test at a load of 100 mN and calculated by the following Equation (2), is 32.4% or more:
$${η}_{p l a s t} = ( {W}_{p l a s t} / {W}_{total} ) \times 100 ( \% ) . \qquad ( 2 )$$

8. The stylus according to claim 1, wherein the ratio (HIT/Wₚₗₐₛₜ) of the nanoindentation hardness (HIT) to the plastic deformation work (Wₚₗₐₛₜ) as measured by the nanoindentation test at a load 100 mN, of the hard coating, is 4.5 GPa/nJ or less.
